(19) United States
(12) Patent Application Publication
(10) Pub. No.: US 2005/0154580 A1
(43) Pub. Date: Jul. 14, 2005

(54) Automated grammar generator (AGG)

(75) Inventors: David Horowitz, London (GB); Pierce Buckley, London (GB)

Correspondence Address: OSHA LIANG L.L.P., 1221 MCKINNEY STREET, SUITE 2800, HOUSTON, TX, 77010, US

(73) Assignee: Vox Generation Limited

(21) Appl. No.: 10/976,030

(22) Filed: Oct. 28, 2004

(30) Foreign Application Priority Data
Oct. 30, 2003 (GB) 0325378.8

(51) Int. Cl. G06F 17/27

(52) U.S. Cl. 704/9

(57) ABSTRACT

An automated grammar generator is disclosed, which is operable to receive a speech or text segment. The automated grammar generator identifies one or more parts of the segment suitable for processing into a natural language expression. The natural language expression is an expression which a person might use to refer to the segment. The automatic grammar generator generates one or more phrases from the segment, each of the one or more phrases corresponding to or capable of it being processed into a natural language expression or utterance suitable for referencing the text or speech segment. Noun phrases and verb phrases and other syntactic structures are identified in the speech or text segment, and modified to produce typical natural language expressions or utterances a user might employ to reference a segment. Verbs in verb phrases may be modified in order to provide further natural language expressions or utterances for use in the grammar. The natural language expressions thus generated may be included in grammars or language models to produce models for recognition using an automatic speech recogniser in a spoken language interface.

The present invention relates to an automated grammar generator, a method for automated grammar generation, a computer program for automated grammar generation and a computer system configured to generate a grammar. In particular, but not exclusively, the present invention relates to real-time or on-line generating grammar for dynamic option data in a Spoken Language Interface (SLI), but the invention also applies to the off-line processing of data.

The use of SLIs is widespread in multimedia and telecommunications applications for oral and aural human-computer interaction An SLI comprises functional elements to allow speech from a user to direct the behaviour of an application. SLI's, known to the applicant comprise a number of key sub-elements, including but not restricted to an automatic speech recognition system (ASR), a text to speech (TTS) system, a dialog manager, application managers, and one or more applications with links to external data sources. Session and notification manager(s) allow authentication and context persistence across sessions and context interruptions. Dialogue models (or rules) and language models (possibly comprising combinations of statistical models and grammar rules) are stored in appropriate data-structures such that they may be updated without modification of SLI subsystems. An example of a TTS converter is described in the Applicant's International Patent Application No. PCT/GB02/003738 incorporated herein by reference.

Many, and increasingly more, SLI, applications are implemented in scenarios where the human-machine communication takes place via audio channels, for example via a telephone call. Such applications can allow interaction through other channels or modalities (e.g. visual display, touch devices, pointing devices, gesture capture, etc.). Many such scenarios require the human user to concentrate carefully on what audio is output by the machine, and to make a selection from a list of options repeating the exact words used to identify the selected item in the list. Long lists or periods of having to interact with such a machine, and having to remember lists or the listed items exactly often puts users off from using the application. This is exacerbated if the spoken language has to be unnatural or ungrammatical, for example if the user can only use a particular set of terms or format to input commands or requests to the SLI. Known spoken language systems use a statistical language modelling system with string-matching of model results to generate grammatical rules (“grammars”) for recognising spoken language input. One example is described in a paper found on the World Wide Web at http://www.andreas-kellner.de/papers/KelPor01.pdf (downloadable on 28 May 2003):
Authors: Andreas Kellner and Thomas Portele
Title: “SPICE—A Multimodal Conversational User Interface to an
Electronic Program Guide”
Conference: ISCA Tutorial and Research Workshop on Multi-Modal Dialogues in Mobile Environments, Kloster Irsee (Germany),
Date: June 2002.

The system described in this paper allows users to refer to and request TV programmes and give instructions (e.g. “record Eastenders”). A disadvantage of this prior art is that because there is no process for deriving grammars for new data, it is necessary for a static statistical language model to be built, in an offline process, with a large enough vocabulary to capture most TV programmes. In this case the language model has 14,000 words. In practice, this means that a significant amount of time must be invested in the collection of domain specific data and the development of such a static statistical language model. Secondly, the system must include a hand-coded parser to extract elements of the user utterances.

Another example of a known grammar induction system is disclosed in a paper found at http://www.stanford.edu/˜alexgru/ssp115.pdf on the World Wide Web (downloadable on 28 May 2003):
Author: Alexander Gruenstein
Stanford University, Computational Semantics Lab, California
Date: Mar. 18, 2002

This example includes the program-code for the system. The system merely takes a string of words and builds a grammar by expanding the string into all possible sub-strings and omitting those which cause ambiguity with other items in the current context.

One of the disadvantages of this approach is that it can only deal effectively with very short strings. Thus it would be unfeasible for strings of more than about 6 words, since it would produce almost all possible sub-strings. This would result in far too many permutations to build compact grammars. Strings of this length would occur frequently in many applications.

A second disadvantage is that this approach only allows extremely limited use of natural references by the user. For example:
a) there is no way to handle noun or prepositional phrase variations; and
b) there is no way to handle verb phrase morphology.

Additionally, error rates are very high, i.e. 26-30%.

Examples of systems implementing limited “dynamic grammar generation” are the Nuance Recogniser available from Nuance Communications, Inc., of 1005 Hamilton Court, Menlo Park, Calif. 94025 on which information was available from (http://www.nuance.corn/prodsery/prodnuance.html) on 28 May 2003, and the Speech Works OSR available from Speechworks, International, Inc., of 695 Atlantic Avenue, Boston, Mass. 02111 and about which information was available from http://www.speechworks.com/products/speechrec/openspeechrecognizer.cfm), on 28 May 2003.

These and other speech recognition companies offer the ability to perform late-binding on grammars. Grammars which use this facility are referred to as dynamic grammars. In practice, this means that parts of grammars can be loaded on-line just before it is required for recognition. For example, a grammar which allows users to refer to a list of names, will have a reference to the current name list (e.g. the list of contacts in a users MS Outlook address book). This name list is dynamic, i.e. names can be added, deleted and changed, therefore it should be reloaded each time the grammar is used. This type of late-binding can be used for other types of data also, e.g. any field in a database (e.g. addresses, phone numbers, lists of restaurants, names of documents) or structured utterances like those referring to dates, times, numbers, etc.

However, such systems can only handle data of a particular pre-defined type, e.g. predefined menu options. In particular, the system has no ability to deal with arbitrary strings of words.

Secondly, such systems cannot modify utterances to build natural language utterances. They simply take data in a predefined form and load it into a grammar before the grammar is used.

The present invention was developed with the foregoing problems associated with known SLIs in mind, in particular, avoiding a drop in recognition accuracy, seeking to reduce the burden of concentration on a user, and make the user's interaction with SLIs more natural (e.g. allowing the system to prepare recognition models over an effectively unlimited vocabulary).

Viewed from a first aspect the present invention provides an automated grammar generator operable to receive a text segment, and to identify one or more parts of said text segment suitable for processing into a natural language expression for referencing said segment. The natural language expression being an expression a human might use to refer to the said segment.

Viewed from a second aspect the present invention provides an automated grammar generator operable to receive a speech segment, convert said speech segment into a text segment, and to identify one or more parts of said text segment suitable for processing into a natural language expression for referencing said segment. The natural language expression being an expression a human might use to refer to the said segment.

Viewed from a third aspect the present invention provides a method of automatically generating a grammar, the method comprising receiving a text segment, and identifying one or more parts of the text segment suitable for processing into a natural language expression for referencing the segment. The natural language expression being an expression a human might use to refer to the segment.

Viewed from a fourth aspect the present invention provides a method of automatically generating a grammar, the method comprising receiving a speech segment, converting said speech segment into a text segment, and identifying one or more parts of the text segment suitable for processing into a natural language expression for referencing the segment. The natural language expression being an expression a human might use to refer to the segment.

An embodiment in accordance with various aspects of the invention automatically create grammars comprising natural language expression corresponding to the speech or text segment. The automatic creation of a grammar means that the grammar may be created in real-time or at run-time of a spoken language interface. Thus, the spoken language interface may be used with data items such as text or speech segments which can change or be updated rapidly. Thus, speech language interfaces may be created for systems in which the data items rapidly change, yet are capable of recognising and responding to natural speech expressions thereby giving a realistic and “natural” quality to a user's interaction with the speech language interface. embodiments of the invention may also be used to process arbitrary strings of words or similar tokens (e.g. abbreviations, acronyms) on-line (i.e. during an interaction with a user) or off-line (prior to an interaction).

In this way, it is possible to build a grammar for an automatic speech recognition system from modified segments with the inclusion of common phrases and filler words.

An embodiment of the present invention is particularly useful for systems providing “live” information without the need for manual grammar construction which would result in an unacceptable delay between the update of data and a user being able to access it via the speech language interface. It should be noted that the interface need not be a speech language interface, but may be some other form of interface operable to interpret any mode of user input. For example, the interface may be configured to accept handwriting as an input, or informal text input such as abbreviated text as is used for “text messaging” using mobile telephones.

In one example, an automated grammar generator generates one or more phrases from one or more parts of the segment by “phrase chunking” the segment, one or more of the phrases corresponding to one or more natural language expressions, thereby providing a greater number of phrases corresponding to or suitable for processing into natural language expressions than the number of suitable parts or input phrases in the segment. The one or more phrases automatically generated using phrase chunking results in new words or phrases being generated not present in the original speech or text segment. Such augmented variations allow more natural language usage and improved usability of any speech language interface utilising a grammar generated in accordance with one or more embodiments of the invention.

In a particular example a syntactic phrase is identified, for example using a term extraction module, and phase chunking is used to generate one or more variations of the syntactic phrase to automatically generate the one or more phrases. In an embodiment in which a syntactic phrase is identified, the level of granularity in the grammar, and thereby the natural language expressions recognised for referencing the segment, is high since phrases from the longest to the smallest form a part of the grammar. Embodiments of the present invention need not be limited to producing stand-alone rule based grammars. The parts of speech, syntactic phrases and syntactic and morphological variations generated by an embodiment of the present invention may also be used to populate classes in a statistical language model.

An example of a syntactic phrase is a noun phrase, and a syntactic phrase may be used to generate one or more phrases each comprising one or more nouns from the noun phrase. In this way, grammar items which identify a single noun to a group of nouns are generated, such grammar items being likely terms of reference for any person or object appearing in a text or speech segment. This facilitates a user paraphrasing a segment, (e.g. newspaper headline, a document title, an email subject line, quiz questions and answers, multiple-choice answers, descriptions of any media content), if they are unable to remember the exact phrase yet are still able to accurately identify the item in which they are interested.

Since the syntax of a noun phrase is context sensitive, for example a group of four nouns may be varied in a different way to a group of two nouns, it is advantageous to identify the largest noun phrase within a segment and consequently a particularly useful embodiment of the invention identifies noun phrases which comprise more than one noun.

In order to generate even more realistic natural language expressions, embodiments in accordance with the invention associate one or more adjectives with an identified noun phrase.

The term extraction module may be operable to include in a general class of noun the following parts of speech: proper noun, singular of mass noun, plural noun, adjective, cardinal number, and adjective superlative. Thus, any parts of speech miss-tagged using one or more of the foregoing list is tolerated and leads to a more robust automatic grammar generator.

Verb phrases may also be identified in the segment, and one or more phrases comprising one or more verbs generated from the identified verb phrases. This provides further variations for forming natural language expressions, and provides a more natural language oriented recognition behaviour for a system implementing a grammar in which such verb phrases are generated. Typically, one or more adverbs are associated with the verb phrase which provide yet further realism in the natural language expression.

Suitably, the tense of a verb phrase is modified to generate one or more further verb phrases, providing yet more realistic natural language expressions. For example, a stem of a verb may be identified and an ending added to the stem in order to modify the verb tense. Another way to modify the tense is to vary the constituents of the verb phrase, for example the word “being” may be added before the past tense of a verb in the verb phrase.

An embodiment of the invention may be implemented as part of an automatic speech recognition system, or as part of a spoken language interface, for example comprising an automatic speech recognition system incorporating an embodiment of the present invention.

In an embodiment of the invention, the spoken language interface may be operable to support a multi-modal input and/or output environment, thereby to provide output and/or receive input information in one or more of the following modalities: keyed text, spoken, audio, written and graphic.

A typical embodiment comprises a computer system incorporating an automated grammar generator, or automated speech recognition system, or a spoken language interface.

An automatic speech recognition system, or speech language interface, implemented in a computer system as part of an automated information service may comprise one or more of the services from the following non-exhaustive list: a news service; a sports report service; a travel information service; an entertainment information service; an e-mail response system; an Internet search engine interface; an entertainment service; a cinema ticket booking; catalogue searching (book titles, film titles, music titles); TV program listings; navigation service; equity trading service; warehousing and stock control, distribution queries; CRM—Customer Relationship Management (call centres); Medical Service/Patient Records; and interfacing to Hospital data.

An embodiment of the invention may also be included in a user device in order to provide automatic speech recognition or a spoken language interface. Optionally, or additionally, the user device provides a suitable interface to an automatic speech recognition system or speech language interface. A typical user device could be a mobile telephone, a Personal Digital Assistant (PDA), a lap-top computer, a web-enabled TV or a computer terminal.

Optionally, a user device may form part of a communications system comprising a computer system including a spoken language interface and the user device, the computer system and user device operable to communicate with each other over the communications network, and wherein the user device is operable to transmit a text or speech segment to the computer system over the communications network, the computer system generating a grammar in the computer system for referencing the segment. In this way, suitable text or speech segments may be communicated from a remote location to a computer system running embodiments of the present invention, in order to produce suitable grammars.

At least some embodiments of the present invention reduce, and may even remove, the need to build large language models prior to the deployment of an automatic speech recognition or speech language interface system.

This not only reduces the time to develop the system, but embodiments of the invention have been shown to have a much higher recognition accuracy than conventional systems. The low error rate is a result of the compact, yet natural, representation of the current context. Typically, a grammar generated in accordance with an embodiment of the present invention has a vocabulary of less than 100 words, and often less than 20 words. Such a grammar, or parts of the grammar, can be used as part of another grammar or other language model.

In particular, some embodiments of the present invention adapt the context for a particular speech or text segment, and so reduce the amount of inappropriate data, indeed seek to exclude such inappropriate data, from the grammar. However large the vocabulary of a language model in an existing system, it generally cannot cover all the possible utterances in all contexts. Furthermore, embodiments of the current invention obviate the need for a hand-coded parser to provide the parses of the strings for matching. The appropriate semantic representation is built into the grammar/parser according to the current context.

Additionally, an embodiment of the current invention can also be combined with statistical language models to allow the user to form utterances over a large vocabulary while at the same time showing information from the current context is also accessible. Embodiments of the current invention can adapt to the context whilst a language model (e.g. statistical) covers more general utterances. The flexibility of this approach is assisted by the ability of embodiments of the current invention to adapt to the context in a spoken language system.

A particularly useful aspect of examples of the present invention is that arbitrary strings of words can be used as an input. The arbitrary strings of words can be modified to produce new strings which allow users to refer to data using natural language utterances. Both phrase variations and morphological variations are used to generate the natural language utterances.

Particular embodiments and implementations of the present invention will be described hereinafter, by way of example only, with reference to the accompanying drawings in which like reference signs relate to like elements and in which:

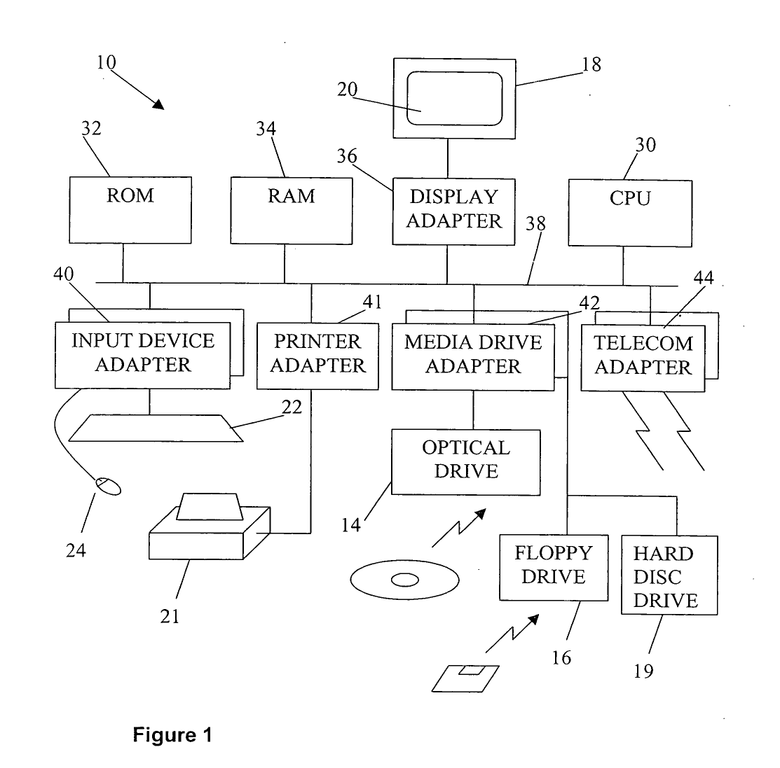

FIG. 1 shows a schematic representation of a computer system;

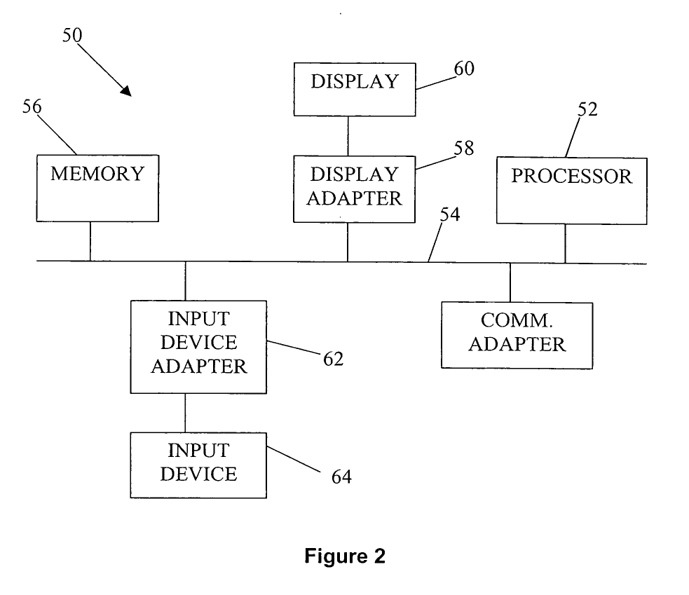

FIG. 2 shows a schematic representation of a user device;

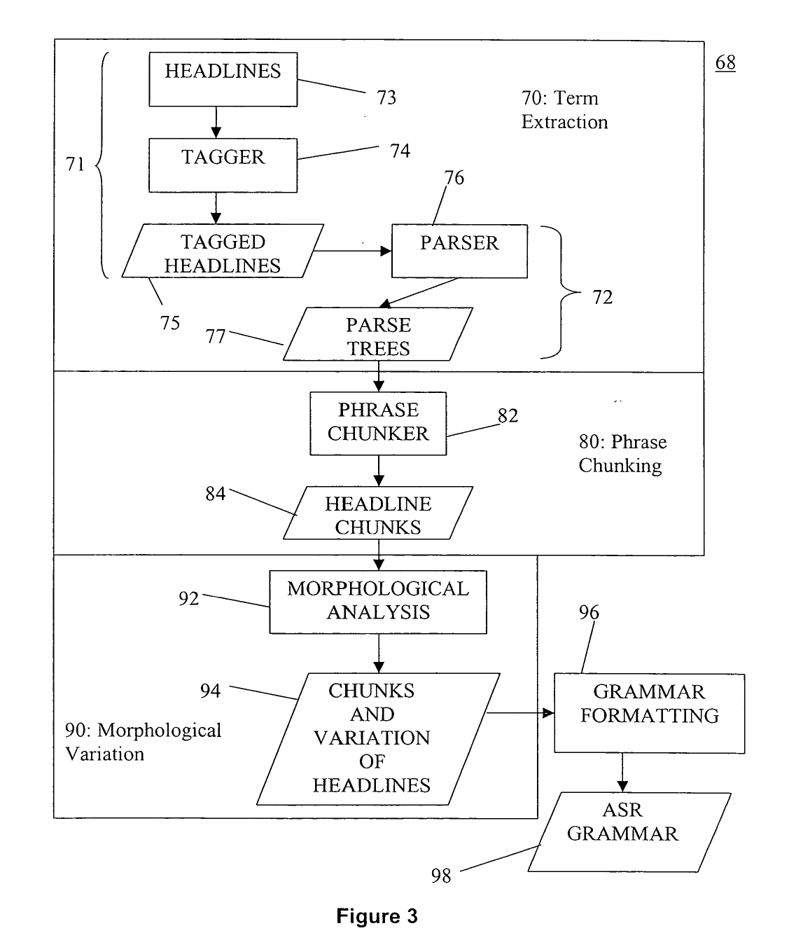

FIG. 3 illustrates a flow diagram for an AGG in accordance with an embodiment of the invention;

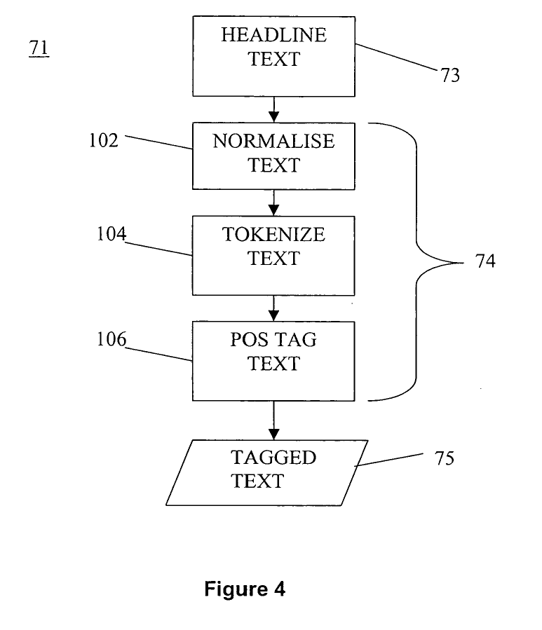

FIG. 4 illustrates a flow diagram for a POS tagging sub-module of the AGG;

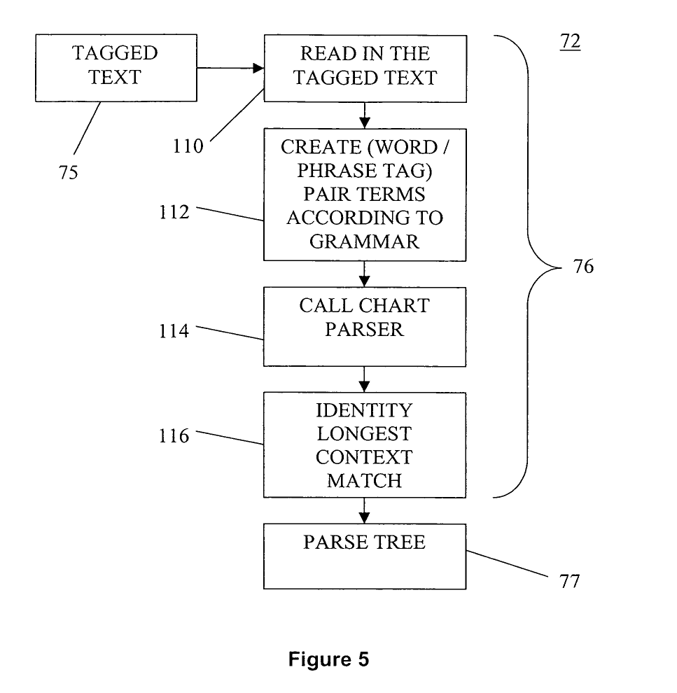

FIG. 5 illustrates a flow diagram for a parsing sub-module of the AGG;

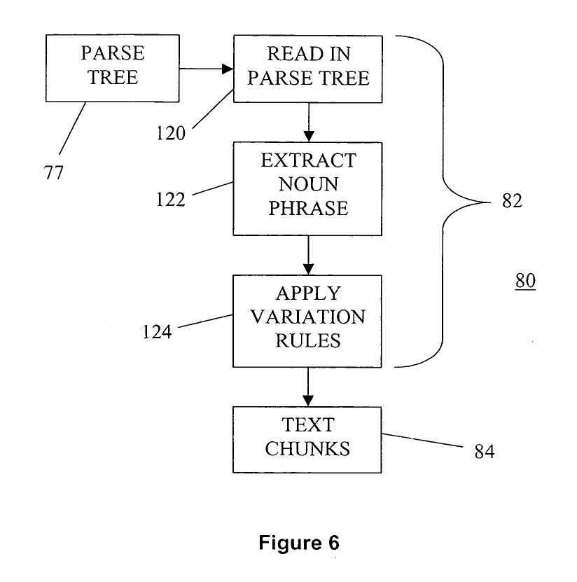

FIG. 6 illustrates a flow diagram for a phrase chunking module of the AGG;

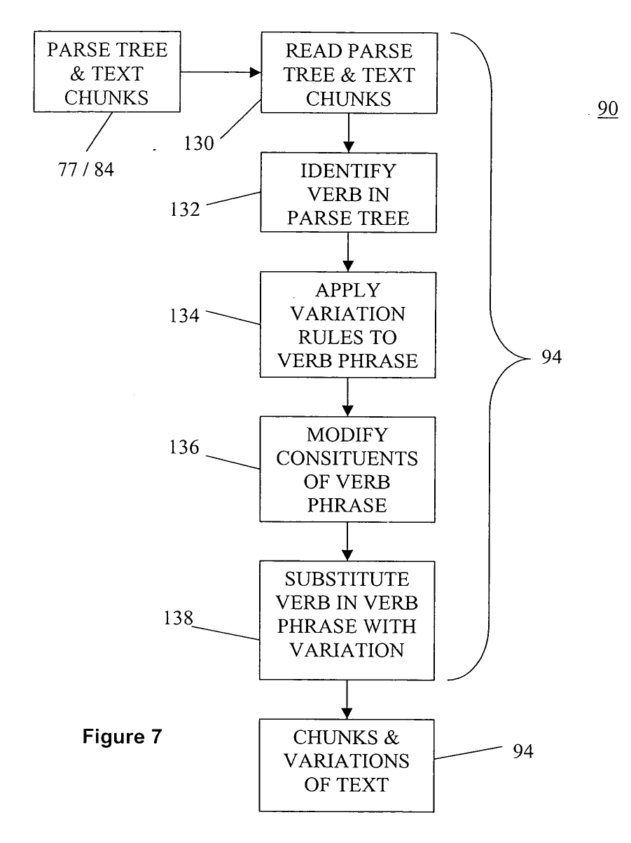

FIG. 7 illustrates a flow diagram for a morphological variation module of the AGG;

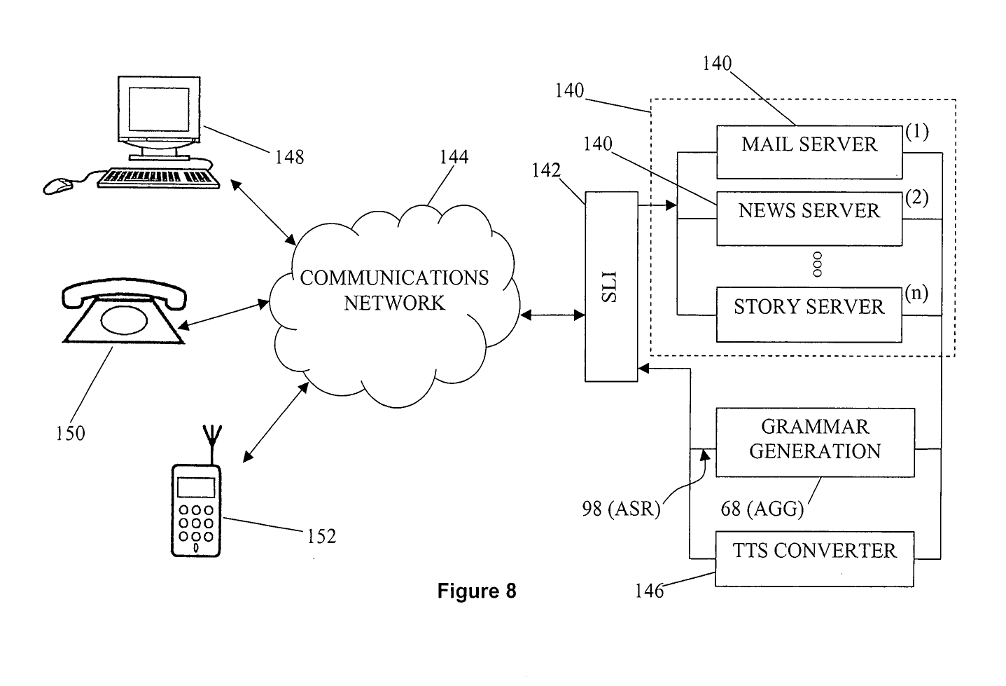

FIG. 8 schematically illustrates a communications network incorporating an AGG;

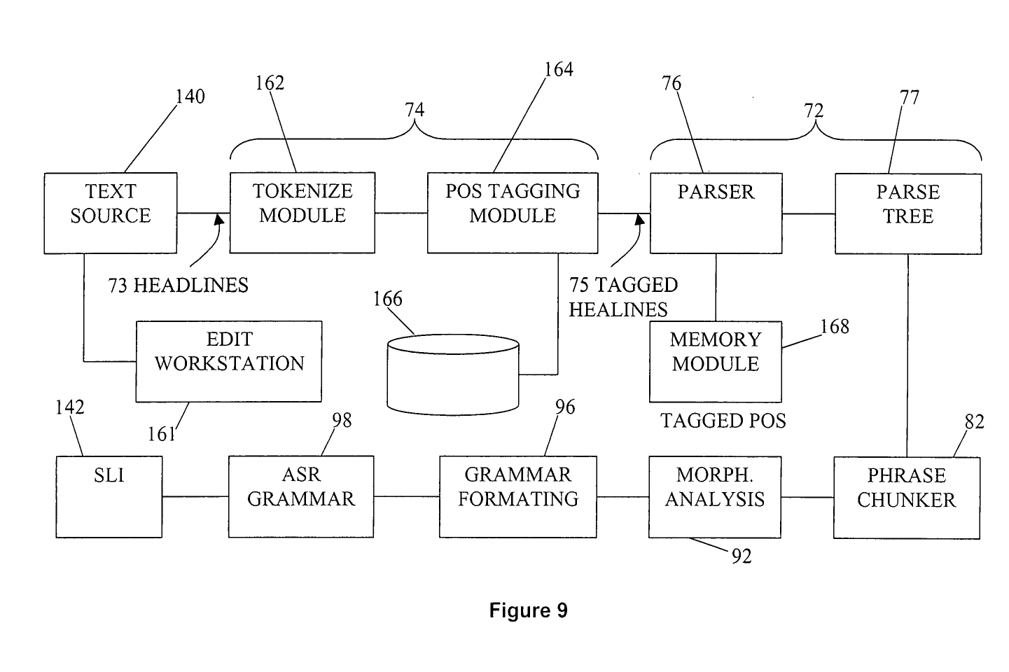

FIG. 9 schematically illustrates a SLI system incorporating an AGG.

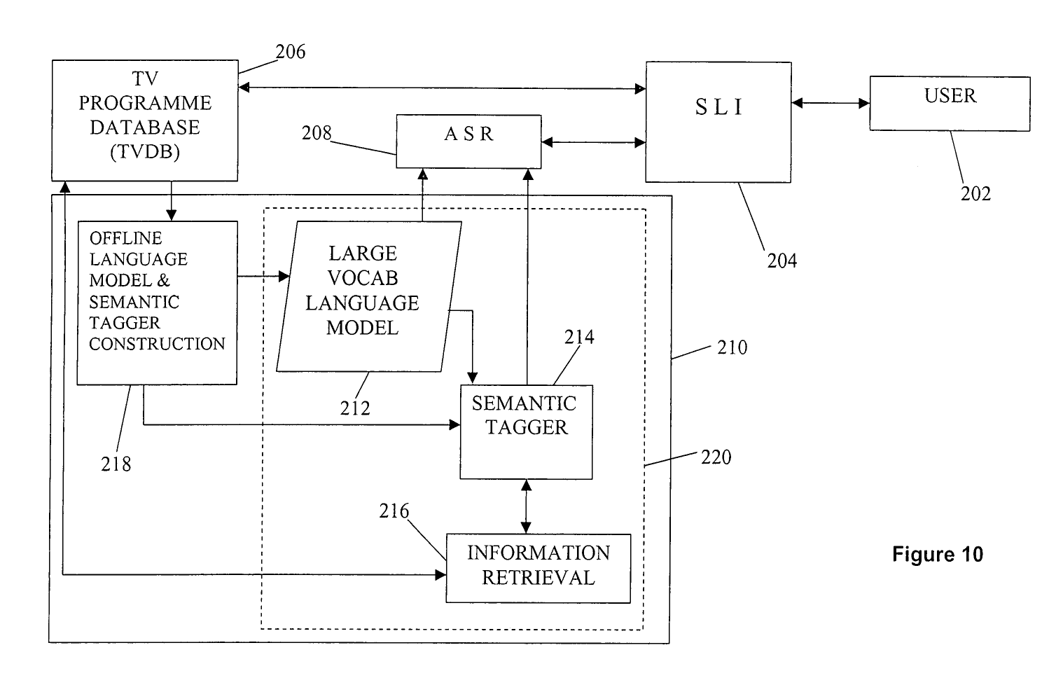

FIG. 10 is a top level functional diagram illustrating a conventional implementation of a grammar generator with a SLI and AGR; and

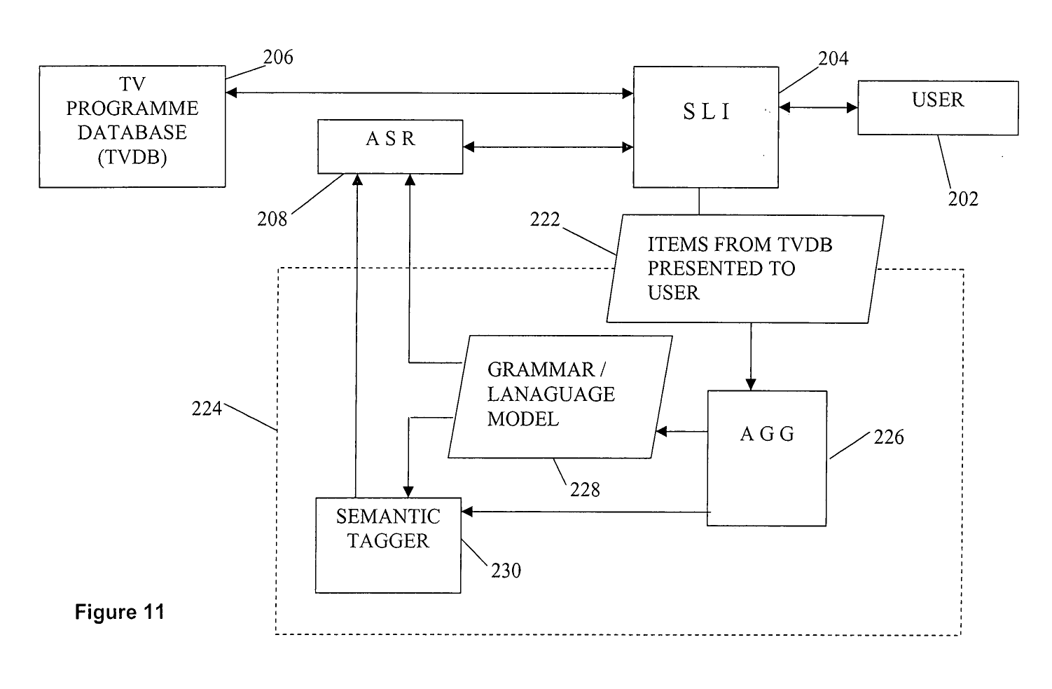

FIG. 11 is a top level functional diagram illustrating an implementation of an automatic grammar generator in accordance with an embodiment of the present invention with an SLI and AGR

FIG. 1 shows a schematic and simplified representation of a data processing apparatus in the form of a computer system 10. The computer system 10 comprises various data processing resources such as a processor (CPU) 30 coupled to a bus structure 38. Also connected to the bus structure 38 are further data processing resources such as read only memory 32 and random access memory 34. A display adapter 36 connects a display device 18 having screen 20 to the bus structure 38. One or more user-input device adapters 40 connect the user-input devices, including the keyboard 22 and mouse 24 to the bus structure 38. An adapter 41 for the connection of the printer 21 may also be provided. One or more media drive adapters 42 can be provided for connecting the media drives, for example the optical disk drive 14, the floppy disk drive 16 and hard disk drive 19, to the bus structure 38. One or more telecommunications adapters 44 can be provided thereby providing processing resource interface means for connecting the computer system to one or more networks or to other computer systems or devices. The communications adapters 44 could include a local area network adapter, a modem and/or ISDN terminal adapter, or serial or parallel port adapter etc, as required.

The basic operations of the computer system 10 are controlled by an operating system which is a computer program typically supplied already loaded into the computer system memory. The computer system may be configured to perform other functions by loading it with a computer program known as an application program, for example.

In operation the processor 30 will execute computer program instructions that may be stored in one or more of the read only memory 32, random access memory 34 the hard disk drive 19, a floppy disk in the floppy disk drive 16 and an optical disc, for example a compact disc (CD) or digital versatile disc (DVD), in the optical disc drive or dynamically loaded via adapter 44. The results of the processing performed may be displayed to a user via the display adapter 36 and display device 18. User inputs for controlling the operation of the computer system 10 may be received via the user-input device adapters 40 from the user-input devices.

A computer program for implementing various functions or conveying various information can be written in a variety of different computer languages and can be supplied on carrier media. A program or program element may be supplied on one or more CDs, DVDs and/or floppy disks and then stored on a hard disk, for example. A program may also be embodied as an electronic signal supplied on a telecommunications medium, for example over a telecommunications network. Examples of suitable carrier media include, but are not limited to, one or more selected from: a radio frequency signal, an optical signal, an electronic signal, a magnetic disk or tape, solid state memory, an optical disk, a magneto-optical disk, a compact disk and a digital versatile disk.

It will be appreciated that the architecture of a computer system could vary considerably and FIG. 1 is only one example.

FIG. 2 shows a schematic and simplified representation of a data processing apparatus in the form of a user device 50. The user device 50 comprises various data processing resources such as a processor 52 coupled to a bus structure 54. Also connected to the bus structure 54 are further data processing resources such as memory 56. A display adapter 58 connects a display 60 to the bus structure 38. A user-input device adapter 62 connects a user-input device 64 to the bus structure 54. A communications adapter 64 is provided thereby providing an interface means for the user device to communicate across one or more networks to a computer system, such as computer system 10 for example.

In operation the processor 52 will execute instructions that may be stored in memory 56. The results of the processing performed may be displayed to a user via the display adapter 58 and display device 60. User inputs for controlling the operation of the user device 50 may be received via the user-input device adapter 60 from the user-input device. It will be appreciated that the architecture of a user device could vary considerably and FIG. 2 is only one example. It will also be appreciated that user device 50 may be a relatively simple type of data processing apparatus, such as a wireless telephone or even a land line telephone, where a remote voice telephone apparatus is connected/routed via a telecommunications network.

Spoken Language Interfaces (SLIs) are found in many different applications. One type of application is an interface for providing a user with a number of options from which the user may make a selection or in response to which give a command. A list of spoken options is presented to the user, who makes a selection or gives a command by responding with an appropriate spoken utterance. The options may be presented visually instead of, or in addition to, audible options for example from a text to speech (TTS) conversion system. Optionally, or additionally, the user may be permitted to refer to recently, although not currently, presented information. For example, the user may be allowed to refer to recent e-mail subject lines without them being explicitly presented to the user in the current dialogue interaction context.

SLIs rely on grammars or language models to interpret a user's commands and responses. The grammar or language model for a particular SLI defines the sequences of words that the user interface is able to recognise, and consequently act upon. It is therefore necessary for the SLI dialogue designer to anticipate what a user is likely to say in order to define the set of utterances as fully as possible as recognised by the SLI. In order to recognise what the user says the grammar or language model must cover a large number of utterances making use of a large vocabulary.

Grammars are usually written by trained human grammar writers. Independent grammars are used for each dialogue state that the user of an SLI may encounter. On the other hand, statistical language models are trained using domain specific utterances. Effectively the language model encodes the probability of each sequence of words in a given vocabulary. As the vocabulary grows, or the domain less specific, the recognition accuracy achieved using the language model decreases. While it is possible to build language models over large vocabularies and relatively unconstrained domains, this is extremely time consuming and requires very large amounts of data for training. In addition such language models still have a limited vocabulary when compared with the size of vocabulary used in ordinary conversation. At the same time, statistical language models offer the best means to recognise such utterances. Many applications use statistical language models where particular tokens in the language model are effectively populated by grammars. An embodiment of the present invention can be used to generate either stand-alone grammars or grammar fragments to be incorporated in other grammars or language models. In what follows, the terms grammar, phrase chunk, syntactic chunk, syntactic variant/.variation, morphological variant/.variation, phrase segment should be understood as possible constituents of grammars or language models.

In terms of integration into a SLI, grammars have been classified into two subcategories: static and dynamic grammars.

So-called static grammars are used for static dialogue states which are constant, i.e. the information that the user is dealing with never, or rarely, changes. For example, when prompted for a four digit pin number the dialogue designer (grammar writer) can be fairly certain that the user will always say four numbers. Static grammars can be created offline by a grammar writer as the set they describe is predictable. Such static grammars can be written by human operators since the dialogue states are predictable and/or static.

Dynamic grammars is a term used when the anticipated set of user utterances can vary. For example, a grammar maybe used to refer to a list of names. The list of names may correspond to the contacts in a user's MS Outlook address book. The name list, i.e. contacts address book, is dynamic since names can be added, deleted and changed, and should be re-loaded each time the grammar is to be used. An example of a known system comprising dynamic grammars are available from Nuance Communications, Inc., or SpeechWorks International, Inc.

However, grammar writing using human grammar writers is time consuming and impractical for situations in which what the user is likely to say is dependent on quickly changing information or options, for example a voice interface to an internet search engine, or any application where content is periodically updated, such as hourly or daily. This limitation of human grammar writers inhibits the development of truly “live systems”.

An example of a typical interaction of a conventional grammar writer or generator with a SLI using an ASR will now be described with reference to FIG. 10 of the drawings. A user 202 communicates with an SLI 204 in order to interrogate a TV programme database (TVDB) 206. The SLI 204 manages the interaction with the user 202. Communication between the SLI 204 and the user 202 can occur via a number of user devices, for example a computer terminal, a land line telephone, a mobile telephone or device, a lap top computer, a palm top or a personal digital assistant. A particularly suitable interaction between the user 202 and SLI 204 is one which involves the user speaking to the SLI. However, the SLI 204 may be implemented such that the user interaction involves the use of a keyboard, mouse, stylus or other input device to interact with the SLI in addition to voice utterances. For example, the SLI 204 can present information graphically, for example text e.g. SMS messages, as well as using speech utterances. A typical platform for the SLI 204, and indeed the ASR 208 and the conventional grammar or language model system 210, is a computer system, or even a user device for some implementations, such as described with reference to FIGS. 1 and 2 above.

In operation, the SLI 204 accesses the TVDB 206 in order to present items to the user 202, and to retrieve items requested by the user 202 from the TVDB 206. As mentioned above, items can be presented to the user 202 in various ways depending on a particular communications device being used. For example, on an ordinary telephone without a screen a description of items would be read to the user 202 by the SLI 204 using suitable speech utterances. If the user device had a screen, then items may be displayed graphically on the screen. A combination of both graphical and audio presentation may also be used.

In order to interpret user utterances, the ASR 208 is utilised. The ASR 208 requires a language model 212 in order to constrain the search space of possible word sequences, i.e. the types of sentences that the ASR is expected to recognise. The language model 212 can take various forms, for example, a grammar format or a finite state network representing possible word sequences. In order to produce a semantic representation, usable by the ASR 208 and SLI 204, of what the user has requested a semantic tagger 214 is utilised. The semantic tagger 214 assigns appropriate interpretations to the recognised utterances, for example, to the utterances of the user (which may contain references to the information retrieved, 216, from TVDB 206). The language model 212 and semantic tagger 214 are produced in an off-line process 218. This off-line process typically involves training a large vocabulary language model comprising thousands of words and building a semantic tagger, generally using human grammar writers. The large vocabulary language model is generally a statistical N-gram, where N is the maximum length of the sub-strings used to estimate the word recognition probabilities. For example, a 3-gram or tri-gram would estimate the probability of a word given the previous two words, so the probabilities are calculated using strings of three words. Note that in other implementations a statistical semantic component is trained using tagged or aligned data. A similar system could also use human authored grammars or a combination of such grammars with a language model.

As can be seen from the foregoing, whilst a significant number of elements of the grammar or language model system 210 are located on the computer platform 220 and may be automated, a very large amount of the work in generating the grammar or language model has to occur in an off-line process 218. Not only do the automated processes 220 have to sift through a large vocabulary, but are inhibited from reacting to requests for quickly changing data, since it is necessary for the language model 212 to be appropriately updated with the grammar corresponding to the new data. However, such updates can only be achieved off-line. Thus, such a conventional grammar system mitigates against the use of an SLI and ASR system in which the interaction between the SLI and user is likely to change and require frequent updating.

Embodiments of the present invention will now be described, by way of example only. For illustrative purposes only, the embodiments are described implemented in a rolling news service. It will be clear to the ordinarily skilled person that embodiments of the invention are not limited to news services, but may be implemented in other services including those which do not necessarily have rapidly changing content.

The coverage of a grammar may be defined as the set of utterances that a user might use in a given dialogue state over the set of utterances defined by grammar. If a grammar has low coverage then the SLI is less likely to understand what the user is saying, increasing mis-recognition leading to a reduction in both performance and usability.

In one example of a rolling news service application, an SLI is provided which allows a user to call up and ask to listen to a news item of their choice, selected from a list of news items. The news service may operate in the following way.

Given the following headline:
a) 268 m haul of high-grade cocaine seized;
   a standard automatically created grammar would only allow a user to refer to the news story described by the headline by uttering the whole of sentence a), or by using some kind of numbering system which would allow them to say ‘Give me the nth headline,’ “Get the last one” or “Read the next one,” thereby navigating the system using the structure of the news, item archive.

Other than these highly restrictive forms of response, standard automatically created dynamic grammars do not account for any type of variation in the way in which a user might ask for an item. This results in a highly unnatural and mechanistic user interaction, which leads to frustration, dislike and avoidance by users of such conventional SLI systems. For example, in a natural human dialogue a user might reference article a) with phrases such as those given in b) below:
b) ‘Give me the one about the [high-grade cocaine]’
   ‘Read the story about [cocaine]’
   ‘Read the story about [cocaine being seized]’

In these examples, users have added extra words to the words in square brackets extracted directly from the headline.

Users may also vary the form of the words which they have just heard when referencing a headline. For example, on hearing or reading the following headlines:
c) Hundreds of guns go missing from police store
   Ex-security chief questioned over Mont Blanc disaster

The user may use these verb variations to reference the headlines:
d) ‘I want the story about the ex-security chief being questioned’.
   ‘Give me the one about guns going missing from the police store’.

A conventional dynamic grammar would consist solely of the unvaried version of headlines a) and c). The only way in which the user could select a given news story would be to cite the whole headline verbatim. This results in an extremely inconvenient way of navigating the system as the user cannot use the same natural phrases that they would use in normal conversation such as those given in commands b) and d).

Grammars such as the varied versions given in command b) and d), could be created by human grammar writers. However, to support a fully dynamic news system, in which new stories are received (for example) four times a day either grammars would have to be authored by hand continuously or all out of vocabulary items would have to be incorporated in the language model or grammar being used for recognition. The first possibility is obviously not really feasible, since a grammar writing team would have to be on hand for whenever new stories arrived. The team would then have to manually enter a grammar pertinent to each news story and ensure each grammar item will send back the correct information to the news service application manager. That is to say, check that use of a grammar item provides the correct information to the application manager to select the desired news station. As this is a time consuming process, the time between receiving the headlines from an outside news provider and making them available to the user of the SLI is lengthy, and mitigates against the immediacy of the news service, thereby making it less attractive to users. The second option is a far more flexible solution. An embodiment of the current invention provides the only technology to process arbitrary text and automatically determine the appropriate segments and segment variants, which should be used in the language model or grammar for recognition.

In general terms an Automatic Speech Recognition (ASR) system may incorporate an example of an Automated Grammar Generator (AGG) which uses syntactic and morphological analysis and variation to address the above problem and rapidly produces grammars in a short time frame, in order that they can be integrated as quickly as possible into the news service application. Syntactic and morphological analysis and variation is sometimes termed “chunking”, and produces “chunks” of text (a word or group of words) that form a syntactic phrase. This results in the stories being presented to the user sooner than if the grammar writing process had been carried out manually. Grammars generated by embodiments of the invention also create better grammar than a conventional automated system which simply extracts non-varied terms. Instead, embodiments of the invention may extract and form likely permutations and variations of a grammar item that a user may utter such as commands b) and d) above, thus creating a grammar which better predicts the possible utterances. The AGG may be selective with regard to which syntactic variations it extracts so that it does not over generate the predicted utterance set. Lack of suitable selection and restriction of predictive morphological syntactic variation can result in poor accuracy. The modules used to generate these variations can incorporate parameters determined statistically from data or set by the system designers to control the types and frequency of the variation.

Broadly speaking, embodiments of the invention process each headline by breaking them down into a series of chunks, such as those demonstrated in square brackets in b), using a syntactic parser that identifies the structure of the sentence with parts of speech (POS). The chunks are chosen to represent segments of the headline that a user may say in order to reference the news story. Embodiments may also allow the user to use variations of these chunks and indeed the whole headline. The extracted chunks are passed through various variation modules, in order to obtain the chunk variations. These modules can use a variety of implementations. For example, the parser module could be a chart parser, robust parser, statistical rule-parser, or a statistical model to map POS-tagged text to tagged segments.

Embodiments of the present invention may be implemented in many ways, for example in software, firmware or hardware or a combination of two or more of these.

The basic operation of an AGG 68, for example implemented as a computer program, will be described with reference to the flow diagram illustrated in FIG. 3. As can be seen from FIG. 3, headline chunking is broken down into 3 main stages or modules: term extraction 70, chunking 80, and morphological and syntactic variation 90.

The term extraction module 70 provides a syntactic analysis of a text or audio portion such as a headline 73. The term extraction module 70 includes two sub-modules; Part of Speech (POS) tagging sub module 71, and parsing sub-module 72. The POS tagging sub-module 71 assigns a POS tag, e.g. ‘proper noun’, ‘past tense noun’, ‘singular noun’ etc, to each word in a headline. Parsing sub-module 72 operates on the POS tagged headline to identify syntactic phrases, and produce a parse tree of the headline. The phrase chunking module 80 includes a phrase chunker 82 which produces headline chunks 84. The phrase chunker 82 takes the parsed headline and identifies chunks of each headline which may be used to reference the story to which the headline refers. In general, the headline chunks will be noun phrases although not always. The noun phrases are extracted and used as grammar items for the headline. Variations of the noun phrases are created by the phrase chunker 82 in order to account for the likely variations a user may use to reference the headline. The original and varied noun phrases form the headline chunks 84 output from the phrase chunking module 80.

As well as varying the noun phrases, i.e. syntax, of a headline, a user may also reference the headline using a different word or words to the original. For example, a verb tense may be changed. This changing or using different words is undertaken by the morphological variation module 90, which includes a morphological analysis unit 92 outputting headline chunks and variations, 94.

The chunks and variations of the headlines 94 are then input to a grammar formatting unit 96 which outputs a formatted machine generated ASR grammar 98.

There are various grammar formats used in ASR. The example below uses GSL (Grammar Syntax Language) (Information available at http://cafe.bevocal.com/docs/grammar/gsl.html on Oct. 28, 2003 A GSL grammar format for the following 3 headlines:
Headline 1: Owner barricades sheep inside house
Headline 2: Patty Hearst to be witness in terror trial
Headline 3: China warns bush over Taiwan
including various possible syntactic segments is:
HEADLINE
[
([(owner)(barricades)(sheep)(house)(?sheep ?inside house)(owner barricades ?sheep?inside house)]) {<headline_id 12>}
([(patty ?hearst)(hearst)(witness)(?terror trial)(?witness in ?terror trial)(?patty?hearst to be ?witness in ?terror trial)]) {<headline _id 14>}
([(china)(bush)(taiwan)(?over taiwan)(?bush over ?taiwan)(?china warns ?bush ?over?taiwan)]) {<headline_id 5>}

The grammar title is “HEADLINE”, and each separate set of headline chunks and variations are associated with a headline identity “<headline_idn)”. Each chunk or variation is enclosed in parenthesis, with questions marks (“?”) indicating an optional item. Other suitable formats may be used.

Elements of the AGG mechanism 68 illustrated in FIG. 3 will now be described in more detail.

Term Extraction

The term extraction module provides a syntactic analysis for each headline 73 in the form of a parse tree, which is then used as a basis for further processing in the following two modules. The parse tree produced may be partial or incomplete, i.e. a robust parser implementation would return the longest possible syntactic substrings but could ignore other words or tokens in between. For example, the term extraction module takes a headline such as:
e) judge backs schools treatment of violent pupil; and returns a parse tree:
f) s(np(judge)vp(backs)np(schools treatment)pp(of np(violent pupil)));
   where the terms “s”, “np”, “vp” and “pp” are examples of parse tree labels corresponding to a sentence, noun phrase, verb phrase and prepositional phrase (see also appendix B).

Term extraction is broken down into two constituent sub-modules, namely part of speech tagging 71 and parsing 72 now described in detail with reference to the flow diagrams of FIGS. 4 and 5 respectively.

Part of Speech Tagging

Referring now to FIG. 4, an example of the operation of POS tagging sub-module 71 will now be described. Headline text 73 is input to Brill tagger 74. A Brill tagger requires text to be tokenised. Therefore, headline text 73 is normalised at step 102, and the text is broken up into individual words. Additionally, abbreviations, non-alphanumeric characters, numbers and acronyms are converted into a fully spelt out form. For example, “Rd” would be converted to “road”, and “$” to “dollar”. A date such as “1997” would be converted to “Nineteen ninety seven” or “One thousand, nine hundred and ninety seven” (it if is a number). “UN” would be converted to “United Nations”. The conversion is generally achieved by the use of one to one look-up dictionaries stored in a suitable database associated with the computer system upon which the AGG program is running. Optionally, a set of rules may be applied to the text which take into account preceding and following contexts for a word. Optionally, control sequences may be used to separate different modes. For example, a particular control signal may indicate a “mathematical mode” for numbers and mathematical expressions, whilst another control sequence indicates a “date mode” for dates. A further control sequence could be used to indicate an “e-mail” mode for e-mail specific characters.

The text is tokenised at step 104, which involves inserting a space between words and punctuation so, for example, the headline text:
g) thousands of Afghan refugees find no shelter.
   would become;
h) thousands of Afghan refugees find no shelter “\hat{ }”.

As can be seen from text portion h) there is a space “\hat{ }” inserted between the last word of the sentence and the full stop.

The tokenised text portion is then tagged with parts of speech tags. The POS tagging 106 is implemented using a Brill POS computer program tagger, written by Eric Brill. Eric Brill's POS tagger is available from http://www-cgi.cs.cmu.edu/afs/cs.cmu.edu/project/ai-repositort/ai/areas/nlp/parsing/taggers/brill/0.html, and downloadable on 9 Jun. 2003.

The Brill POS tagger applies POS tags using the notation of the Penn TreeBank tag set derived by Pierre Humbert. An example of the Penn TreeBank tag set was available from URL: on 9 Jun. 2003. “http:www.ccl.umist.ac.uk\teaching\material\1019\Lect6\tsld006.htm”,

An example of a Penn TreeBank tag set suitable for use in embodiments of the present invention is included herein at appendix A.

Tagged text 75 results from the POS tagging at Step 106, and would result in tag text 75 as shown below for headline text g) above:
i) thousands\NNS of\IN Afghan\NN refugee\NNS find\VBP no\DT shelter\NN.
   Parsing

As mentioned previously, there are various possible implementations of the parser. The one described in detail herein is a type chart parser. Other possible implementations include, various forms of robust parser, statistical rule-parsers, or more general statistical models to map strings of tokens to segmented strings of tokens. FIG. 5 illustrates the operation of the parser 72, which may be referred to as a “chunking” parser since the parser identifies syntactic fragments of text based on sentence syntax. The fragments are referred to as chunks. Chunks are defined by chunk boundaries establishing the start and end of the chunk. The chunk boundaries are identified by using a modified chart parser and a phase structured grammar (PSG), annotates the underlying grammatical structure of the sentence).

Chart parsing is a well-known and conventional parsing technique. It uses a particular kind of data structure called a chart, which contains a number of so-called “edges”. In essence, parsing is a search problem, and chart parsing is efficient in performing the necessary search since the edges contain information about all the partial solutions previously found for a particular parse. The principal advantage of this technique is that it is not necessary, for example, to attempt to construct an entirely new parse tree in order to investigate every possible parse. Thus, repeatedly encounting the same dead-ends, a problem which arises in other approaches, is avoided.

The parser used in the described embodiment is a modification of a chart parser, known as Gazdar and Mellish's bottom-up chart parser, so-called because it starts with the words in a sentence and deduces structure, downloadable from the URL “http://www.dandelis.ch/people/brawer/prolog/botupchart/” (downloadable Oct. 6, 2003), and modified to:
1) recover tree structures from the chart;
2) return the best complete parse of a sentence; and
3) return the best (longest) partial parse, in the case when no complete sentence parse is available.

The parser is loaded with a phase-structured grammar (PSG) capable of identifying chunk boundaries in accordance with the PSG rules for implementing the described embodiment.

At step 112 (words/phrase, tag) pair terms are created in accordance with the PSG grammar loaded into parser 72. For example, for the following headline:
j) 268 m haul of high-grade cocaine seized;
the POS tagger will produce a tagged headline text 75 comprising (words/phrase, tag) pairs according to the following,
k) 268 m/CD haul/NN of/IN high-grade/JJ cocaine/NN seized/VBD which is read into the parser 72.
   Grammar

A general description of a grammar suitable for embodiments of the invention will now be provided, prior to a detailed description of the PSG rules used in this embodiment. A suitable grammar is a Context Free Phrase Structure Grammar (CFG). This is defined as follows.

A CFG comprises Terminals, Non-terminals and rules. The grammar rules mention terminals (words) drawn from some set Σ, and non-terminals (categories), drawn from a set N. Each grammar rule is of the form:
M [symbol] D₁, . . . ,Dₙ
where MεN (i.e. M is category), and each DᵢεN∪Σ (i.e. it is either a category or a word). Unlike the right-linear grammars, there is no restriction that there be at most one non-terminal on the right hand side.

A CFG is a set of these rules, together with a designated start symbol.

It is a 4-tuple (Σ, N, S₀, P) where:
Σ is a finite set of symbols, known as the terminals;
N is a finite set of categories (or non-terminals), disjoint from Σ;
S₀s₀ is a member of N, known as the start symbol; and
P is a set of grammar rules
A rule of the form M [symbol] D₁, . . . ,Dₙ can be read as, for any strings S₁εD₁, . . . ,SₙεDₙ,S₁ . . . SₙεM
   Rules

The actual rules applied by the parser in step 114 are in the following format:
‘rule(s, [np,vp])’.
where ‘s’ is known as the left hand side of the CFG rule and refers to a sentence, alphanumeric string or extended phrase which is the subject of the rule, and everything after the first comma (the ‘np’ and ‘vp’) represent the right hand side of a CFG rule. The term “np” represents a noun phrase, and the term “vp” represents a verb phrase. In practice, it has been found that the results of the Brill tagger may contain errors, for example a singular noun may be tagged as a plural noun. In order to make the AGG 68 more robust, the grammar is designed to overcome these errors working on the premise that compound nouns can be made up of any members of the set ‘general noun (n)’, and in any order. The category “n” itself comprises the following tags: nnp (proper noun), nn (singular of mass noun), nns (plural noun), jj (adjective), cd (cardinal number), jj (adjective superlative). Therefore, if a noun is miss-tagged as another member of the ‘n’ category any mistakes made by the Brill tagger has no consequence.

An example of a CFG rule set suitable for use in the described embodiment will now be described.

Rule 1) defines the general format of the rules.

The rule set 2-6 states that a np can consist of any combination of the members of set n, varying in length from one to five. Other lengths may be used.

For the described example there are twelve rules, as follows:
1) rule(s, [np,vp]).
2) rule(np, [n]).
3) rule(np, [n,n]).
4) rule(np, [nn,n]).
5) rule(np, [n,n,n,n]).
6) rule(np, [n,n,n,n,n]).

Rules 7-11 define the individual members of set n.
7) rule(n, [nnp]).
8) rule(n, [nn]).
9) rule(n, [nns]).
10) rule(n, [jjs]).
11) rule(n, [cd,cd]).
12) rule(n, [cd]).
   Parsing Algorithm

The rules are stored in a rules database, which is accessed by parser 72 during step 112 to create the word/phrase, tag pairs At step 114 the chart parser is called and applies a so-called greedy algorithm at step 116, which operates such that if there are several context matches the longest matching one will always be used. Given the POS tagged sentence 1) below, and applying rule set m) below, parse tree n) would be produced rather than o). (Where ‘X’ is an arbitrary parse)
l) Ecuador/NNP agrees/VBZ to/TO banana/NN war/NN peace/NN deal/NN
m) rule(np, [n,n,n,n]).
   rule(np,[n,n]),
   rule(np,[np,np]),
   rule(n,[nn]),
n) X[Ecuador/NNP agrees/VBZ to/TO] NP[banana/NN war/NN peace/NN deal/NN]
o) X[Ecuador/NNP agrees/VBZ to/TO] NP[banana/NN war/NN] NP[peace/NN deal/NN]

Parse tree n) comprises a single noun phrase, comprising the two noun phrases found in parse tree o). This discrimination is preferable since the way in which a chunk may be varied in the phrase chunking module is context sensitive. For example, a group of four nouns (NN's) may be varied in a different manner to two groups of two nouns (NN's).

Phrase Chunker

Phrase Chunking

Referring back to FIG. 3, the parse tree 77 (n) in the foregoing example) is input to the phrase chunking module 80. Once the noun phrases (NPs) have been identified they can be extracted for use as grammar items, so that the user of the system can use them to reference the news story. However, the user may also use variations of those NPs to reference the story. To account for this, further grammar rules are created and applied to the NPs to generate these variations. Another possible means to derive these variations would be to use a statistical model, where parameters are estimated using data on frequency and types of variations. The variations will in turn also be used in the grammar or language model used for recognition. The variations will also be reinserted into the sentence in the position from which their non-varied form was extracted. Therefore, variations must be the same syntactic category as the phrase from which they are derived in order that they can be coherently inserted into the original sentence.

The operation of the phrase chunking module 80 will now be described with reference to FIG. 6.

The parse tree 77 is read into the phrase chunker 82 at step 120. The noun phrase is extracted from the parse tree at step 122.

Variation Rules

At step 124 variation rules are applied to the noun phrase. The variation rules function comprises POS patterns and variations of that POS pattern. The POS pattern for each rule is marked against those parts of speech (POS) found in each noun phrase. These patterns comprise the left hand side of a variation rule, whilst the right hand side of the rule states the variations on the original pattern which may be extracted. An example variation rule is:
p) CD NN→12,2. (see Appendix A)

The variations are given in numerical form. A “1” indicates mapping onto the first POS on the left hand side of the rule, and a “2” indicates mapping onto the second, and so on and so forth. Different variations stated on the RHS of the rule are delimited by a comma. Rule p) therefore reads, ‘if the NP contains a cardinal number (CD)+followed by a noun (NN), then extract them both together as well as the NN on its own’. Following this rule the noun phrase given in q) will produce the variations given in r), because the list of outputs always includes the originals as shown below:
q) NP[268 m/CD haul/NN];
r) NP[268 m/CD haul/NN];
   NP[haul/NN].

The variations are reinserted into to the original sentence (in the position previously held by the noun phrase from which they were derived) to produce the combinations below:
s) [268 m haul of high-grade cocaine] seized; and
   [haul of high-grade cocaine] seized.

The extractions and their variations themselves are also legitimate utterances that a user could potentially say to reference a story, so these are also added as individual grammar items, such as the following:
t) 268 m haul; and
   haul.

The varied text, the extractions and variations of the extractions form text chunks 84. The text chunks 84 are stored, for example, in a run-time grammar database and compared with user utterances to identify valid news story selections.

Morphological Variation

As well as varying the syntax of a headline text, the user may also reference the news story using a different word form to the original text. For example, the following headlines:
u) Hundreds of guns go missing from police store; and
   Ex-security chief questioned over Mont Blanc disaster;
      could be referred to as:
v) ‘I want the story about the ex-security chief being questioned’ and;
   ‘Give me the one about guns going missing from the police store’;
      in which the varied verb form has been shown underlined. This illustrates a significant advance on known approaches, and which can result in a user having a more natural interaction with an SLI encompassing an embodiment of the invention.

The operation of the morphological variation module 90 will now be described with reference to FIG. 7. The operation of the morphological variation module 90 is similar to the way in which the variation rules apply in phrase chunker 82 of phrase chunking module 80. Firstly, parse tree 77 and text chunks 84 are read into the morphological analysis element 92 of the morphological variation module at step 130. Next, at step 132, the verb phrases are identified in the parse tree. The verb phrases are extracted, and at step 134 are varied in accordance with verb variation rules. In one embodiment, the verb-variation rule comprises two parts, a left hand side and a right hand side. The left hand side of a verb-variation rule contains a POS tag, which is matched against POS tags in the parse tree, and any matches cause the rule to be executed. The right hand side of the rule determines which type of verb transformation can be carried out. The transformations may involve adding, deleting or changing the form of the constituents of the verb phrase. In the following example the parse tree;
w) women VP [sickened\VBD] by film;
   operated on by the rule VBD->being+VBD; results in the present continuous form of the verb phrase, i.e. “women being sickened by film”.

Another example of a verb variation rule is one which changes the form of the verb itself to its “ing” form. This sort of verb variation rule is complex, since there is a great deal of variation in a way in which a verb has to be modified in order to bring it into its “ming” form. An example of the application of the rule is shown below.
x) dancers [entertain\VB] at disco,
   when having the rule VB->VB to 'ing applied to it, becomes
y) dancers entertaining at disco.

The foregoing example is relatively simple since the verb ending did not need modifying prior to adding the “ming” suffix. However, not all examples are so straight forward. Table 1 below sets out a set of morphological rules for changing the form of a verb to its “ing” form depending upon the ending of the verb (sometimes referred to as the left context) to determine whether or not the verb ending needs altering before the “ming” suffix is added. In example ‘w’ no left context match is found with reference to Table 1 and so the stem has not been altered prior to adding the “ming” suffix.

TABLE 1

| Left Context | Action | Add |
|---|---|---|
| er | Remove er | ing |
| e | Remove e | ″ |
| v | Double last | ″ |
| {b, d, g, l, m, n, p, r, s, t} | consonant | |
| None of above | No action | ″ |

At step 136, any variations of the verb phrase are then reinserted into the original sentence or text chunks 84 (and varied forms) thereby modifying the constituents of the verb phrase in accordance with the verb variation rules.

In this way a set of text chunks and variations of those text chunks together with the original text and variation of the text is produced, step 94. The set of text chunks and variations 94 is output from the AGG 68 to a grammar formatting module 96.

An example of a more complete set of verb variation rules may be found at appendix C included herein. By way of brief explanation, appendix C comprises a table (Table A) in which the verb pattern for matching against the verb phrase is illustrated in the left most column. The right most column illustrates the rule to be applied to the verb for a verb phrase matching the pattern shown in the corresponding left hand most column. The middle two columns illustrate the original form of the verb phrase and the varied form of the verb phrase. Appendix C also includes a key explaining the meaning of various symbols in the table.

For completeness, appendix C also includes a table (Table B) setting out the morphological rule for adding “ing”, as already described above. Additionally the relevant tables for adding “ing” for a verb, third person singular present “VBZ”, and verb, non-third person singular present “VBP”, respectively are included as tables C and D in Appendix C.

Appendix C also includes a rule e) and f) (the rule for irregular verbs).

There has now been described an Automated Grammar Generator which forms a list of natural language expressions from a text segment input. Each of the natural language expressions being expressions which a user of a SLI might user to refer to or identify the segment.

An illustrative example of an AGG in a network environment is illustrated in FIG. 8. An AGG 68 is configured to operate as a server for user devices whose users wish to select items from a list of items. The AGG 68 is connected to a source 140 including databases of various types of text material, such as e-mail, news reports, sports reports and children's stories. Each text database may be coupled to the AGG 68 by way of a suitable server. For example, a mail database may be connected to AGG 68 by way of a mail server 140(1) which forwards e-mail text to the AGG. Suitable servers such as a news server 146 (2) and a story server 140 (n) are also connected to the AGG 68. Each server 106 (1,2 . . . n) provides an audio list of the items on the server to the AGG. The Automatic Speech Recognition Grammar 98 is output from the AGG 68 to the SLI interface where it is used to select items from the servers 140 (1,2 . . . n) responsive to user requests received over the communications network 144.

The communications network 144 may be any suitable, or combination of suitable communications networks, for example Internet backbone services, Public Subscriber Telephone Network (PSTN), Plain Old Telephone Service (POTS) or Cellular Radio Telephone Networks for example. Various user devices may be connected to the communications network 134, for example a personal computer 144, for example a personal computer 148, a regular landline telephone 150 or a wireless/mobile telephone 152. Other sorts of user devices may also be connected to the communications network 134. The user devices 148, 150, 152 are connected to the SLI via communications network 144 and suitable network interface.

In the particular example illustrated in FIG. 8, SLI 142 is configured to receive spoken language requests from user devices 142, 150, 152 for material corresponding to a particular source 140. For example, a user of a personal computer 140 may request, via SLI 140, a news service. Upon receiving such a request SLI 4 accesses news server 140 to cause (2) to cause a list of headlines 73, or other representative extracts, to be forwarded to the AGG. An ASR grammar is formed from the headlines and is forwarded from AGG 68 to SLI 144 where it is used to understand and interpret user requests for particular news items.

Optionally, for a request from a mobile telephone 152, the SLI 142 may be connected to the text source 140 by way of a text to speech converter which converts the various text into speech for output to the user over communications network 144. As will be evident to persons of ordinary skill in the art, other configurations and arrangements may be utilised and embodiments of the invention are not limited to the arrangement described with reference to FIG. 8.

An example of the implementation of an AGG 68 in a computer system will now be described with reference to FIG. 9 of the drawings. Each of the modules described with reference to FIG. 9 may utilise separate memory resources of a computer system such as illustrated in FIG. 1, or the same memory resources logically separated to store the relevant program code for each module or sub-module.

A text source 140 supplies a portion of text to tokenise module 162, part of Brill tagger 74. Suitably, the text portion should be unformatted, and well-structured. Via editing workstation 161 a human operator may produce and/or edit a text portion for text source 140.

The text portion is processed at the tokenize module 162 in order to insert spaces between words and punctuation.

The tokenized text is input to POS tagger 164, which in the described example is a Brill Tagger and therefore requires the tokenised text prepared by tokenised module 164. POS Brill Tagger 164 assigns tags to each word in the tokenised text portion in accordance with a Penn TreeBank POS tag set stored in database 166. POS tagged text is forwarded to parser 176 on parsing sub-module 72, where it undergoes syntactic analysis. Parser 76 is connected to a memory module 168 in which parser 76 can store parse trees 77 and other parsing and syntactic information for use in the parsing operation. Memory module 168 may be a dedicated unit, or a logical part of a memory resource shared by other parts of the AGG.

Parsed text tree 77 is forward to a phrase chunker 82, which outputs headline or text chunks 84 to morphological analysis module 92. The headline chunks and variants are output to Grammar formatter 96, which provides ASR Grammar to SLI 142.

There has now been described not only an automatic grammar generator, but also examples of a network incorporating a system using automatic grammar generation, and an SLI system incorporating an automatic grammar generator.

A particular implementation built by the applicant comprises an on-line grammar generator using an automatic grammar generator as described in the foregoing, and a front-end user interface which allows a user to interact with a news story service. In a typical interaction the user hears a list of headlines and then requests the story he wishes to hear by referring to it using a natural language expression.

For example, the system utters the following headlines:
“Another MP steps into race row”
“Past Times chain goes into administration”
“Owner barricades sheep inside house”

The user can respond in the following way:
“Play me the story about the MP stepping into the row”

The set of headlines offered by the system describe the current context which is passed to the on-line grammar generator. The on-line grammar generator then processes the headlines as described above with reference to the automatic grammar generator, and formats the resulting strings to produce a grammar for recognition. This grammar allows users to optionally use pre-ambles like “play me the story about”, “play the one about”, and “get the one on”, etc.

From the above example interaction, it is clear that both phrase and morphological variations are required to produce strings which would allow the users expression or utterance to be recognised. Phrases which are varied are “the row” from “race row” and morphological variation resulting in “stepping” from “steps”.

Using example headlines such as set out above, a corpus of user utterances or expressions was collected by the applicant. In total 147 utterances were collected from speakers. In order to test the system, a random selection of headlines from a set of 160 headlines was made. The headlines were harvested from the current news service provided by the Vox virtual personal assistant, available from Vox Generation Limited, Golden Cross House, 8 Duncannon Street, London WC2N 4JF. Analysis of the results established that 90% of user utterances resulted in the selection of the correct headlines. The results showed that this particular example of the invention performs very well within the context of speech recognition systems. In particular, the ability to generate grammars rich enough and compact enough to recognise utterances such as those provided in the example above is a particular feature of examples of the present invention.

Referring now to FIG. 11, the interaction of an embodiment of the invention with a SLI and ASR will now be described to allow comparison with the interaction of conventional grammar systems with SLIs and ASRs.

As is the case with the conventional system illustrated in FIG. 10, a user 202 interacts with a SLI 204 in a number of ways using a number of various devices. The TVDB 206 is interrogated by the SLI 204 in order for data items to be presented to the user for selection. User utterances are transferred from the SLI 204 to the ASR 208.

At any particular time, the SLI 204 will be aware of items which have been presented to the user, most typically because those items have been presented by the SLI itself. The data items from the TVDB presented to the user, 222, are passed to a grammar writing system 224, and in particular into an embodiment of the AGG 226. The AGG 226 processes the items in accordance with the processes described herein for example, in order to produce the grammar/language model 228 and semantic tagger 230 (for example as a grammar such as described in the foregoing). The grammar/language model 228 and semantic tagger 230 are then utilised by the ASR 208 in order to recognise utterances of the user in order to appropriately select items from the TVDB 206. Note that it is also possible for items from the TVDB 206 to be passed to AGG 226 to allow off-line preparation of grammars and/or language models.

As clearly demonstrated with reference to FIG. 11, all of the grammar system 224 may be implemented in a computer system, for example the same computer system in which the ASR 208 and SLI 204 are implemented. This is because there is no off-line process necessary for generating a grammar or language model. The grammar/language model 228 is generated by the AGG 226 which is automated and may be implemented in the computer system which the rest of the grammar system 224 resides. Thus, it is possible for systems utilising AGGs in accordance with embodiments of the present invention to have quickly changing data, since new grammars may be written quickly, and in response to a new data item during execution or run-time of the system. The need for off-line processing is substantially reduced and may be removed completely. In some applications, it may be beneficial to use AGG to prepare grammars or language models off-line. AGG is not limited to either on-line or off-line processes, it can be used for both.

Insofar as embodiments of the invention described above are implementable, at least in part, using a computer system, it will be appreciated that a computer program for implementing at least part of the described AGG and/or the systems and/or methods and/or network, is envisaged as an aspect of the present invention. The computer system may be any suitable apparatus, system or device. For example, the computer system may be a programmable data processing apparatus, a general purpose computer, a Digital Signal Processor or a microprocessor. The computer program may be embodied as source code and undergo compilation for implementation on a computer, or may be embodied as object code, for example.

Suitably, the computer program can be stored on a carrier medium in computer usable form, which is also envisaged as an aspect of the present invention. For example, the carrier medium may be solid-state memory, optical or magneto-optical memory such as a readable and/or writable disk for example a compact disk and a digital versatile disk, or magnetic memory such as disc or tape, and the computer system can utilise the program to configure it for operation. The computer program may be supplied from a remote source embodied in a carrier medium such as an electronic signal, including radio frequency carrier wave or optical carrier wave.

In view of the foregoing description of particular embodiments of the invention it will be appreciated by a person skilled in the art that various additions, modifications and alternatives thereto may be envisaged. For example, more than one sentence, phrase, headline, a paragraph of text or other type of text (e.g. SMS text shorthand) may be input to the AGG 68, thereby providing a corpus of text to be operated on. Each sentence, phrase, headline or test may be operated on individually to produce the chunks and variations, but the resulting grammar comprises elements for all the headlines input to the AGG 68. Although the embodiment described herein has used a Brill tagger, other forms of speech tagger may be used. In the described implementation of the Brill tagger the normalisation and tokenization of text is part of the Brill tagger itself. The skilled person would understand that one or both of normalisation and tokenization may be part of the pre-processing of headline text, prior to it being input to the Brill tagger itself. Additionally, the POS tags need not be as specifically described herein, and the tags set may comprise different elements. Likewise, a parser other than a chart parser may be used to implement embodiments of the invention.

Although embodiments have been described in which the grammar has been automatically generated from text, the source for the grammar could be voice. For example, a voice source could undergo speech recognition and be converted to text from which a grammar may be generated.

It will be immediately evident to the skilled person that that the AGG mechanism may form part of a central server which automatically generates the grammar associated with the text describing information items. However, the AGG may be implemented on a user device to produce an appropriate grammar to which the user device responds by sending a suitable selection request to the information service (news service etc). For example, a control character or signal maybe initiated following the correct user utterance. Such an implementation may be particularly useful in a mobile environment where bandwidth considerations are significant.

The scope of the present disclosure includes any novel feature or combination of features disclosed therein either explicitly or implicitly or any generalisation thereof irrespective of whether or not it relates to the claimed invention or mitigates any or all of the problems addressed by the present invention. The applicant hereby gives notice that new claims may be formulated to such features during the prosecution of this application or of any such further application derived therefrom. In particular, with reference to the appended claims, features from dependent claims may be combined with those of the independent claims and features from respective independent claims may be combined in any appropriate manner and not merely in the specific combinations enumerated in the claims.

Appendix A

The Penn Treebank tagset

| | | |
|---|---|---|
| 1. | CC | Co-ordinating conjunction |
| 2. | CD | Cardinal number |
| 3. | DT | Determiner |
| 4. | EX | Existential there |
| 5. | FW | Foreign word |
| 6. | IN | Preposition or subordinating conjunction |
| 7. | JJ | Adjective |
| 8. | JJR | Adjective, comparative |
| 9. | JJS | Adjective, superlative |
| 10. | LS | List item marker |
| 11. | MD | Modal |
| 12. | NN | Noun, singular or mass |
| 13. | NNS | Noun, plural |
| 14. | NP | Proper noun, singular |
| 15. | NPS | Proper noun, plural |
| 16. | PDT | Predeterminer |
| 17. | POS | Possessive ending |
| 18. | PP | Personal pronoun |
| 19. | PP$ | Possessive pronoun |
| 20. | RB | Adverb |
| 21. | RBR | Adverb, comparative |
| 22. | RBS | Adverb, superlative |
| 23. | RP | Particle |
| 24. | SYM | Symbol |
| 25. | TO | to |
| 26. | UH | Interjection |
| 27. | VB | Verb, base form |
| 28. | VBD | Verb, past tense |
| 29. | VBG | Verb, gerund or present participle |
| 30. | VBN | Verb, past participle |
| 31. | VBP | Verb, non-3rd person singular present |
| 32. | VBZ | Verb, 3rd person singular present |
| 33. | WDT | Wh-determiner |
| 34. | WP | Wh-pronoun |
| 35. | WP$ | Possessive wh-pronoun |
| 36. | WRB | Wh-adverb |

Appendix B
Parse Tree Labels
S Sentence
np Noun phrase
vp Verb phrase
pp Prepositional phrase
   Appendix C
   Verb Variation Rules
   KEY
+ Add word
= Keep word unchanged
− remove word

+‘ing’ keep word but transform into ‘ing’ form

TABLE A

| | | Change to | |
|---|---|---|---|
| VP pattern | Example | structure | Rule |
| VBN | Mum | Mum being | + being, |
| | sickened | sickened | =VBN |
| | after . . . | | |
| VBD | 9 jobs lost | 9 jobs being | + being, |
| | | lost | =VBD |
| TO VB | Bob to be | Being jailed | −to, VB |
| VBN | jailed | | to ‘ing’ |
| TO VB | Plans to | Countering | −to, VB |
| | counter war | | to ‘ing’ |
| MD VB | Vets will | Deciding | −MD, VB |
| | decide | | to ‘ing’ |
| VBD RB | Family were | Being | VBD to |
| VBN | unlawfully killed | unlawfully killed | ‘ing’ =RB, |
| | | | =VBN |
| MD VB | Aid may | Killing | −MD, − |
| VBD | have killed lover | | VB, VBD to |
| | | | ‘ing’ |
| VB | Dancers | Entertaining | VB to |
| | entertain at disco | | ‘ing’ |
| VBZ JJ | Revenge is | Being sweet | VBZ to |
| | sweet | | ‘ing’, =JJ |
| TO VB | Pupils to | Gaining | −TO, VB |
| (inf) | gain new rights | | to ‘ing’ |
| MD VB | Track can be | NO CHANGE | |
| VBN | heard online | | |
| JJ TO VB | Bob unlikely | Bob being | −JJ, −TO, |
| VBN | to be jailed | jailed | VB to ‘ing’, |
| | | | =VBN |
| VBZ | Law is no | Law being no | VBZ to |
| | defence | defence | ‘ing’ |
| VBP VBN | Airships are | Airships | VBP to |
| TO VB | cleared to fly | being cleared to fly | ‘ing’, =VBN, |
| | | | =TO, =VB |
| VBP JJR | Children | Children | VBP to |
| | walk taller | walking taller | ‘ing’, =JJR |
| VBN CC | Teenager | Teenager | +being, |
| VBN | stripped and | being stripped and | =VBN, =CC, |
| | beaten | beaten | =VBN |
| VBG TO | For refusing | NO | |
| | to | CHANGE | |
| VBN INF | Buglar, | Bulger, being | +being, |
| INF CC VB | Sentenced to | sentenced to learn to | =VBN, =INF, |
| | learn to read | read and write | =INF, =CC, |
| | and write | | =VB |
| VBP TO | Militants | Militants | VBP |
| VP | threaten to take | threatening to take | +ing, =TO, =VP |
| TO VB RB | Tourist to be | Tourist being | −TO, |
| VBN | closely watched | closely watched | VB+ing, =RB, |
| | | | =VBN |
| VBP VBG | Guns go | Guns going | VBP +‘ing’, |
| | missing | missing | =VBG |
| VBP | Predict | Predicting | VBP +‘ing’ |
| VBN INF | Crew woken | Crew being | +being, |
| VB | to help solve | woken to help solve | =VBM, =INF, |
| | problem | problem | =VB |

Morph Rule Set for Adding ‘ing’

TABLE B

| Left Context | Action | Add |
|---|---|---|
| er | Remove er | ing |
| e | Remove e | ″ |
| V | Double last | ″ |
| {b, d, g, l, m, n, p, r, s, t} | consonant | |
| None of above | No action | ″ |

VBZ

TABLE C

| Left Context | Action | Add |
|---|---|---|
| S | Remove s | ing |
| V | Remove s, Double | ″ |
| {b, d, g, l, m, n, p, r, s, t} | last consonant | |
| Es | Remove es | ″ |
| None of above | No action | ″ |

VBP

TABLE D

| Left Context | Action | Add |
|---|---|---|
| e (cause) | Remove e | ing |
| es (makes) | Remove es | ″ |
| None of above | No action | ″ |

e)
   If on own VBD->Being VBD'ed unless followed by NP
f)
Irregular list
Are->being
Is->being

1. An automated grammar generator, operable to:
receive a text segment; and
identify at least one part of said text segment suitable for processing into a natural language expression for referencing said segment, said natural language expression being an expression a human might use to refer to said segment.

2. An automated grammar generator, operable to:
receive a speech segment;
convert said speech segment into a text segment; and
identify at least one part of said text segment suitable for processing into a natural language expression for referencing said segment, said natural language expression being an expression a human might use to refer to said segment.

3. An automated grammar generator according to claim 1, comprising a phrase chunking module operable to generate automatically at least one phrase from said at least one part of said segment, said at least one phrase corresponding to at least one natural language expression.

4. An automated grammar generator according to claim 3, further comprising a term extraction module operable to identify a syntactic phrase in said segment; wherein said phrase chunking module is operable to generate at least one variation of said syntactic phrase, thereby automatically generating said at least one phrase.

5. An automated grammar generator according to claim 4, wherein:
said term extraction module is operable to identify a noun phrase in said segment; and
said phrase chunking module is operable to generate at least one phrase comprising at least one noun from said noun phrase.

6. An automated grammar generator according to claim 5, wherein said term extraction module is operable to identify in said segment a noun phrase comprising a plurality of nouns.

7. An automated grammar generator according to claim 4, wherein said term extraction module is further operable to include within a general class of noun the following parts of speech: proper noun, singular or mass noun, plural noun, adjective, cardinal number, and adjective superlative.

8. An automated grammar generator according to claim 5, wherein said phrase chunking module is further operable to associate at least one adjective with said noun phrase in at least one of said at least one phrase.

9. An automated grammar generator according to of claim 3, wherein:
said term extraction module is operable to identify a verb phrase in said segment; and
said phrase chunking module is operable to generate at least one phrase comprising at least one verb from said verb phrase.

10. An automated grammar generator according to claim 9, wherein said phrase chunking module is further operable to associate at least one adverbs with said verb phrase in at least one of said at least one phrase.

11. An automated grammar generator according to claim 9, further comprising a morphological variation module operable to modify a tense of said verb phrase to generate said at least one phrase.

12. An automated grammar generator according to claim 11, wherein said morphological variation module is operable to identify the stem of a verb in said verb phrase and add an ending to said stem to modify said tense.

13. An automated grammar generator according to claim 11, wherein said morphological variation module is operable to vary the constituents of said verb phrase to modify said tense.

14. An automated grammar generator according to claim 11, wherein said morphological variation module is operable to add the word “being” before the past tense of a verb in said verb phase.

15. An automated speech recognition system comprising an automated grammar generator operable to:
receive a speech segment;
convert said speech segment into a text segment; and
identify at least one part of said text segment suitable for processing into a natural language expression for referencing said segment, said natural language expression being an expression a human might use to refer to said segment.

16. A spoken language interface comprising an automated grammar generator operable to;
receive a speech segment;
convert said speech segment into a text segment; and
identify at least one part of said text segment suitable for processing into a natural language expression for referencing said segment, said natural language expression being an expression a human might use to refer to said segment.

17. A spoken language interface according to claim 16, further operable to support a multi-modal input and/or output environment thereby to provide output and/or receive input information on at least one of the following modalities: keyed, text spoken, audio, written, and graphic.

18. A computer system comprising an automated grammar generator operable to:
receive a text segment; and
identify at least one part of said text segment suitable for processing into a natural language expression for referencing said segment, said natural language expression being an expression a human might use to refer to said segment.

19. An automated information service comprising:
a spoken language interface, wherein the spoken language interface comprises an automated grammar generator operable to:
receive a speech segment;
convert said speech segment into a text segment; and
identify at least one part of said text segment suitable for processing into a natural language expression for referencing said segment, said natural language expression being an expression a human might use to refer to said segment.

20. An automated information service according to claim 19 comprising at least one of the following services: a news service; a sports report service; a travel information service; an entertainment information service; an e-mail response system; an internet search engine interface; an entertainment service; a cinema ticket booking; catalogue searching; TV programme listings; navigation service; equity trading service; warehousing and stock control; distribution queries; Customer Relationship Management; medical service/patient records; and interfacing to a hospital data.

21. A user device comprising an automated grammar generator operable to:
receive a text segment; and
identify at least one part of said text segment suitable for processing into a natural language expression for referencing said segment, said natural language expression being an expression a human might use to refer to said segment.

22. A communications system comprising:
a computer system comprising an automated grammar generator
operable to:
receive a text segment; and
identify at least one part of said text segment suitable for processing into a natural language expression for referencing said segment, said natural language expression being an expression a human might use to refer to said segment;
and a user device,
wherein said computer system and said user device are operable to communicate with each other over a communications network, and
wherein said user device is operable to transmit one of a text segment and a speech segment to said computer system over said communications network, for said computer system generating a grammar for referencing said segment.

23. A method of operating a computer system for automatically generating a grammar comprising:
receiving a text segment; and
identifying at least one part of the text segment suitable for processing into a natural language expression for referencing the segment, said natural language expression being an expression a human might use to refer to said segment.

24. A method of operating a computer system for automatically generating a grammar comprising:
receiving a speech segment;
converting said speech segment into a text segment; and
identifying at least one part of the text segment suitable for processing into a natural language expression for referencing the segment, said natural language expression being an expression a human might use to refer to said segment.

25. The method of claim 23, further comprising automatically generating at least one phrase from said at least one part of said segment wherein said at least one phrase correspond to at least one natural language expression.

26. The method of claim 25, further comprising identifying a syntactic phrase of said segment and generating at least one variation of said syntactic phrase, thereby automatically generating said at least one phrase.

27. The method of claim 26, further comprising:
identifying a noun phrase of said segment; and
generating at least one phrase comprising at least one noun from said noun phrase.

28. The method of claim 27, further comprising identifying a noun phrase comprising more than one noun in said segment.

29. The method of claim 27, further comprising including one or more adjectives associated with said noun phrase in at least one of said at least one phrase.

30. The method of claim 27, further comprising clarifying within a general class of noun the following parts of speech: proper noun, singular of mass noun, plural noun, adjective, cardinal number, and adjective superlative.

31. The method of claim 23, further comprising.
identifying a verb phrase in said segment; and
generating one or more phrases comprising one or more verbs from said verb phrase.

32. The method of claim 31, further comprising including at least one adverb associated with said verb phrase in at least one of said at least one phase.

33. The method of claim 31, further comprising automatically modifying a tense of said verb phrase to generate said at least one phrase.

34. The method of claim 31, further comprising identifying the stem of a verb in said verb phrase and adding an ending to said stem to modify said tense.

35. The method of claim 31, further comprising varying the constituents of said verb phrase to modify said tense.

36. The method of claim 34, further comprising adding the word “being” before the past tense of a verb phrase.

37. A computer program for implementing an automated grammar generator, the automated grammar generator operable to:
receive a text segment; and
identify at least one part of said text segment suitable for processing into a natural language expression for referencing said segment, said natural language expression being an expression a human might use to refer to said segment.

38. A computer usable carrier medium carrying a computer program for implementing an automated grammar generator, the automated grammar generator operable to:
receive a text segment; and
identify at least one part of said text segment suitable for processing into a natural language expression for referencing said segment, said natural language expression being an expression a human might use to refer to said segment.

39. (canceled)

40. (canceled)

41. (canceled)

42. (canceled)

43. (canceled)

44. An automated grammar generator, comprising:
means for receiving a text segment; and
means for identifying at least one part of said text segment for processing into a natural language expression for referencing said segment, said natural language expression being an expression a human might use to refer to said segment.

45. An automated grammar generator, comprising:
means for receiving a speech segment;
means for converting said speech segment into a text segment; and
means for identifying at least one part of said text segment for processing into a natural language expression for referencing said segment, said natural language expression being an expression a human might use to refer to said segment.

46. A method of operating a computer system for automatically generating a grammar, comprising:
a step for receiving a text segment; and
a step for identifying at least one part of said text segment for processing into a natural language expression fore referencing said segment, said natural language expression being an expression a human might use to refer to said segment.

47. A method of operating a computer system for automatically generating a grammar, comprising:
a step for receiving a speech segment;
a step for converting said speech segment into a text segment; and
a step for identifying at least one part of said segment for processing into a natural language expression for referencing said segment, said natural language expression being an expression a human might use to refer to said segment.

48. An automated grammar generator according to claim 2, further comprising a phrase chunking module operable to generate automatically at least one phrase from said at least one part of said segment, said at least one phrases corresponding to at least one natural language expressions.

49. The method of claim 24, further comprising automatically generating at least one phrase from said at least one part of said segment wherein said at least one phrase correspond to at least one natural language expression.

50. A computer system comprising an automated grammar generator configured to:
receive a speech segment;
convert said speech segment into a text segment; and
identify at least one part of said text segment suitable for processing into a natural language expression for referencing said segment, said natural language expression being an expression a human might use to refer to said segment.

51. A computer system comprising an automated speech recognition system, the automated speech recognition system comprising an automated grammar generator operable to:
receive a speech segment;
convert said speech segment into a text segment; and
identify at least one part of said text segment suitable for processing into a natural language expression for referencing said segment, said natural language expression being an expression a human might use to refer to said segment.

52. A computer system comprising a spoken language interface, the spoken language interface comprising an automated grammar generator operable to:
receive a speech segment;
convert said speech segment into a text segment; and
identify at least one part of said text segment suitable for processing into a natural language expression for referencing said segment, said natural language expression being an expression a human might use to refer to said segment.

53. A user device comprising an automated grammar generator configured to:
receive a speech segment;
convert said speech segment into a text segment; and
identify at least one part of said text segment suitable for processing into a natural language expression for referencing said segment, said natural language expression being an expression a human might use to refer to said segment.

54. A user device comprising an automated speech recognition system, the automated speech recognition system comprising an automated grammar generator operable to:
receive a speech segment;
convert said speech segment into a text segment; and
identify at least one part of said text segment suitable for processing into a natural language expression for referencing said segment, said natural language expression being an expression a human might use to refer to said segment.

55. A user device comprising spoken language interface, the spoken language interface comprising an automated grammar generator operable to:
receive a speech segment;
convert said speech segment into a text segment; and
identify at least one part of said text segment suitable for processing into a natural language expression for referencing said segment, said natural language expression being an expression a human might use to refer to said segment.

56. A computer program for implementing an automated grammar generator configured to:
receive a speech segment;
convert said speech segment into a text segment; and
identify at least one part of said text segment suitable for processing into a natural language expression for referencing said segment, said natural language expression being an expression a human might use to refer to said segment.

57. A computer program for implementing an automated speech recognition system, the automated speech recognition system comprising an automated grammar generator operable to:
receive a speech segment;
convert said speech segment into a text segment; and
identify at least one part of said text segment suitable for processing into a natural language expression for referencing said segment, said natural language expression being an expression a human might use to refer to said segment.

58. A computer program for implementing a spoken language interface, the spoken language interface comprising an automated grammar generator operable to:
receive a speech segment;
convert said speech segment into a text segment; and
identify at least one part of said text segment suitable for processing into a natural language expression for referencing said segment, said natural language expression being an expression a human might use to refer to said segment.

59. A computer program for operating a computer system, comprising an automated grammar generator operable to:
receive a text segment; and
identify at least one part of said text segment suitable for processing into a natural language expression for referencing said segment, said natural language expression being an expression a human might use to refer to said segment.

60. A computer program for operating a computer system, comprising an automated grammar generator operable to:
receive a speech segment;
convert said speech segment into a text segment; and
identify at least one part of said text segment suitable for processing into a natural language expression for referencing said segment, said natural language expression being an expression a human might use to refer to said segment.

61. A computer program for implementing a method of operating a computer system for automatically generating a grammar comprising:
receiving a text segment; and
identifying at least one part of the text segment suitable for processing into a natural language expression for referencing the segment, said natural language expression being an expression a human might use to refer to said segment.

62. A computer program for implementing a method of operating a computer system for automatically generating a grammar comprising:
receiving a speech segment;
converting said speech segment into a text segment; and
identifying at least one part of the text segment suitable for processing into a natural language expression for referencing the segment, said natural language expression being an expression a human might use to refer to said segment.
